(19) United States
(12) Patent Application Publication
(10) Pub. No.: US 2026/0289468 A1
(43) Pub. Date: Sep. 24, 2026

(54) METHOD AND SYSTEM FOR PREDICTIVE CONTROL MODEL FOR QUALITY MANAGEMENT

(71) Applicant: HCL Technologies Limited, New Delhi (IN)

(72) Inventors: Svetlana Hemavathy V, Chennai (IN); Raju Palani, Chennai (IN)

(21) Appl. No.: 19/338,017

(22) Filed: Sep. 24, 2025

(30) Foreign Application Priority Data
Mar. 20, 2025 (IN) 202511025378

(51) Int. Cl. G06Q 10/0639; G06Q 10/0631; G06Q 10/0635

(52) U.S. Cl. CPC G06Q 10/0639; G06Q 10/063112; G06Q 10/0635

(57) ABSTRACT

This disclosure relates to method and system for managing process metrics using machine learning model. The system comprises a processor. The system further comprises an input module communicably coupled with the processor. The input module is configured to receive vector data associated with a dataset of a framework for a process. The system further comprises a vector processing unit communicably coupled to the input module. The vector processing unit is configured to preprocess the vector data. The system further comprises a trained machine learning model. The trained machine learning model is configured to receive normalized vector data, predict quality and a real-time metric performance of the process, and recommend one or more directives upon identifying an unknown outlier within the process, and one or more corrective actions upon identifying a known outlier within the process.

### TECHNICAL FIELD

This disclosure relates to computer implemented processes for controlling quality and production, and more particularly to method and system for automated managing of process.

### BACKGROUND

In a business process, quality control and process metrics managements is required to identify potential errors, improve quality, reduce costs and increase revenue of the organization.

In the present state of art, a process modeling technique may use a single statistical model developed from historical data for a typical process. The statistical model may perform quality prediction or fault detection for various different process states of a process. The process modeling technique may determine means (and possibly standard deviations) of process parameters for each of a set of product grades, throughputs, etc., and compares on-line process parameter measurements to these means. The process modeling technique may may further use these comparisons in a single process model to perform quality prediction or fault detection across various states of the process. In this manner, a single process model can be used to perform quality prediction or fault detection while the process is operating in any of the defined process stages or states. The disadvantage of using a single statistical model is it may not fully capture the nonlinear or dynamic variations in different process conditions.

The conventional techniques of project management may identify and reduce errors associated with a business process in order to increase quality and production efficiency of the business process. The conventional techniques may include five steps, that are defining, measuring, analyzing, improving, and controlling. However, these steps may be implemented in the business process, such that all these steps are performed manually on a worksheet. Such implementation therefore requires human intervention, where a user or an operator performing a quality check (QC) will be required to work on the worksheet. In general, businesses with human intervention are prone to be affected by human errors introduced during the QC. Further, parameters involved in performing the five steps may be perceived differently by different users and there may also be human interpretation bias. In addition to this, upon identification of faults in the business process, different corrective measures may be adopted by the different users. Hence providing a non-uniform and inconsistent solution to recurring problems.

To eliminate the human interpretation bias and reduce the percentage error there is a need to standardize and predefine the steps. Further, a set template and uniform solutions may be required in order to maintain consistency in quality and production in the business process.

Therefore, there is a need for more advanced mechanisms that are capable of reducing error percentage, identifying root causes for one or more errors and implementing corrections in real time.

### SUMMARY

In one embodiment, a method for managing process metrics using machine learning models is disclosed. The method comprises receiving via an input module, vector data associated with a dataset of a framework for a process, the vector data comprises a set of pre-defined parameters associated with a plurality of users. The pre-defined parameter of the set of pre-defined parameters is associated with a user of the plurality of users based on a pre-defined role of the user, performance metric values associated with the set of pre-defined parameters in one or more steps executed in the process, and a set of pre-defined thresholds pertaining to the set of pre-defined parameters. Each pre-defined threshold indicates an acceptable range of quality for each pre-defined parameter. The method further comprises preprocessing, via a vector processing unit, the vector data. The preprocessing comprises performing vector computations on at least one of the performance metric values and the set of pre-defined thresholds. The method further comprises identifying outliers within the performance metric values using a statistical model. The method further comprises removing outliers to create a normalized vector data. The method further comprises inputting the normalized vector data to a trained machine learning model. The trained machine learning model is configured to predict quality and metric performance of the process in real-time and recommend one or more directives upon identifying an unknown outlier within the process, and one or more corrective actions upon identifying a known outlier within the process.

In another embodiment, a system for managing process metrics using machine learning models. The system comprises a processor. The system further comprises an input module communicably coupled with the processor and configured to receive vector data associated with a dataset of a framework for a process, the vector data comprises a set of pre-defined parameters associated with a plurality of users. Each pre-defined parameter of the set of pre-defined parameters is associated with a user of the plurality of users based on a pre-defined role of the user. The vector data further comprises performance metric values associated with the set of pre-defined parameters in one or more steps executed in the process and the vector data further comprises a set of pre-defined thresholds pertaining to the set of pre-defined parameters. Each pre-defined threshold indicates an acceptable range of quality for each pre-defined parameter. The system further comprises a vector processing unit communicably coupled to the input module and configured to preprocess the vector data. The preprocessing comprises performing vector computations on at least one of the performance metric values and the set of pre-defined thresholds. The preprocessing further comprises identifying outliers within the performance metric values using a statistical model, and the preprocessing further comprises removing outliers to create a normalized vector data. The system further comprises a trained machine learning model, executed by the processor, comprising a neural network with one or more data processing layers. The trained machine learning model is configured to receive the normalized vector data. The trained machine learning model is further configured to predict quality and a real-time metric performance of the process, and the training machine learning model is further configured to recommend one or more directives upon identifying an unknown outlier within the process and the trained machine learning model is further configured to recommend one or more corrective actions upon identifying a known outlier within the process.

In another embodiment, a graphical user interface (GUI) client for managing process metrics using machine learning models on a computing device is disclosed. The GUI client is configured to receive vector data associated with a dataset of a framework for a process. The vector data comprises a set of pre-defined parameters associated with a plurality of users. Each pre-defined parameter of the set of pre-defined parameters is associated with a user of the plurality of users based on a pre-defined role of the user, performance metric values associated with the set of pre-defined parameters in one or more steps executed in the process, and a set of pre-defined thresholds pertaining to the set of pre-defined parameters. Each pre-defined threshold indicates an acceptable range of quality for each pre-defined parameter. The GUI is further configured to render the vector data to an operator, a user input against one or more pre-defined parameters of the pre-defined parameters, one or more directives upon identifying an unknown outlier within the process, and one or more corrective actions upon identifying a known outlier within the process.

In yet another embodiment, a computer program product comprising at least one non-transitory computer-readable storage medium having computer-readable program code is disclosed. The computer-readable program code, when executed, causes a processor to receive, via an input module, vector data associated with a dataset of a framework for a process, the vector data comprises a set of pre-defined parameters associated with a plurality of users. Each pre-defined parameter of the set of pre-defined parameters is associated with a user of the plurality of users based on a pre-defined role of the user, performance metric values associated with the set of pre-defined parameters in one or more steps executed in the process, and a set of pre-defined thresholds pertaining to the set of pre-defined parameters. Each pre-defined threshold indicates an acceptable range of quality for each pre-defined parameter. The processor is further configured to preprocess, via a vector processing unit, the vector data. The preprocessing comprises performing vector computations on at least one of the performance metric values and the set of pre-defined thresholds. The preprocessing further comprises identifying outliers within the performance metric values using a statistical model, and the preprocessing further comprises removing outliers to create a normalized vector data. The processor further configured to input the normalized vector data to a trained machine learning model. The trained machine learning model is configured to predict quality and metric performance of the process in real-time, and the trained machine learning model is further configured to recommend one or more directives upon identifying an unknown outlier within the process, and one or more corrective actions upon identifying a known outlier within the process. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for managing process metrics using machine learning models, in accordance with some embodiments.

FIG. 2 illustrates a functional block diagram of a process metrics managing device implemented by the exemplary system of FIG. 1, in accordance with some embodiments.

FIGS. 3A and 3B illustrate a flow diagram of an exemplary process for managing process metrics using machine learning models, in accordance with some embodiments.

FIG. 4 illustrates a block diagram of a graphical user interface (GUI) for managing process metrics using machine learning models on a computing device, in accordance with some embodiments.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies and mechanisms for carrying out the same purposes of the present disclosure. It should also be realized by those skilled in the art that, such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “comprises”, “comprising”, or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

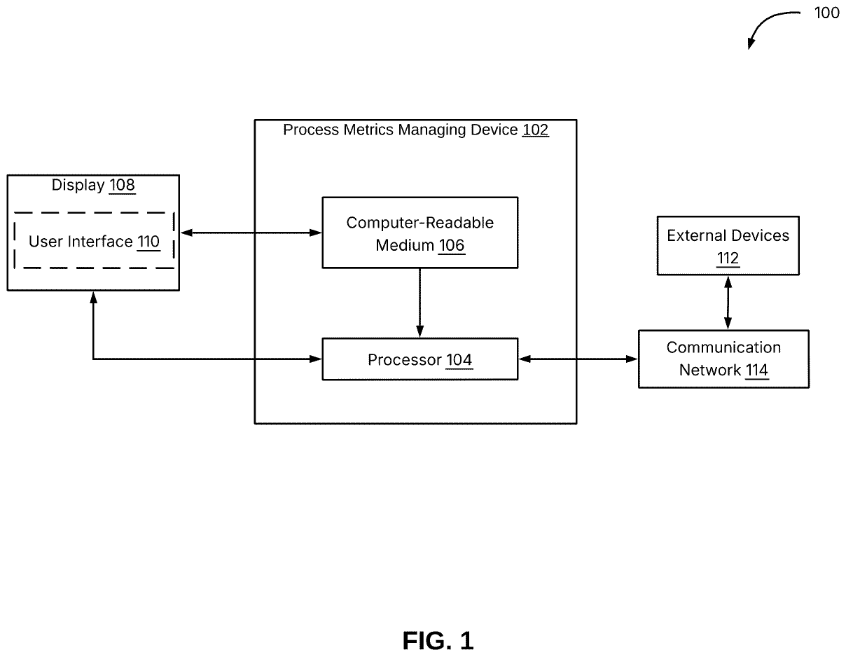

Reference will now be made to the exemplary embodiments of the disclosure, as illustrated in the accompanying drawings. Wherever possible, the same numerals have been used to refer to the same or like parts. The following paragraphs describe the present disclosure with reference to FIGS. 1-5.

Referring now to FIG. 1, an exemplary system 100 for managing process metrics using machine learning models is illustrated, in accordance with some embodiments of the present disclosure. The system 100 may implement a process metrics managing device 102 (for example, server, desktop, laptop, notebook, netbook, tablet, smartphone, mobile phone, or any other computing device), in accordance with some embodiments of the present disclosure. The process metrics managing device 102 may manage process metrics using machine learning models (such as, linear regression, logistic regression, decision tress, random forest, support vector machines, neural networks, k-means clustering, hierarchical clustering, principal component analysis, autoencoders, self-training models, graph-based models, q-learning, deep q networks, policy gradient methods, actor-critic models, convolutional neural networks, recurrent neural networks, transformer models, generative adversarial networks, and the like). It should be noted that, in some embodiments, the process metrics managing device 102 may manage the process metrics using a predictive model.

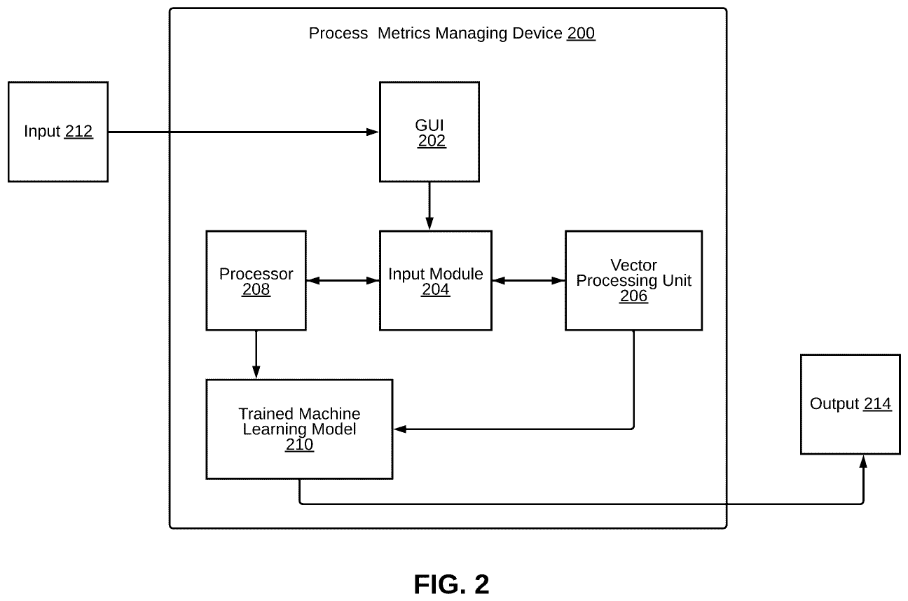

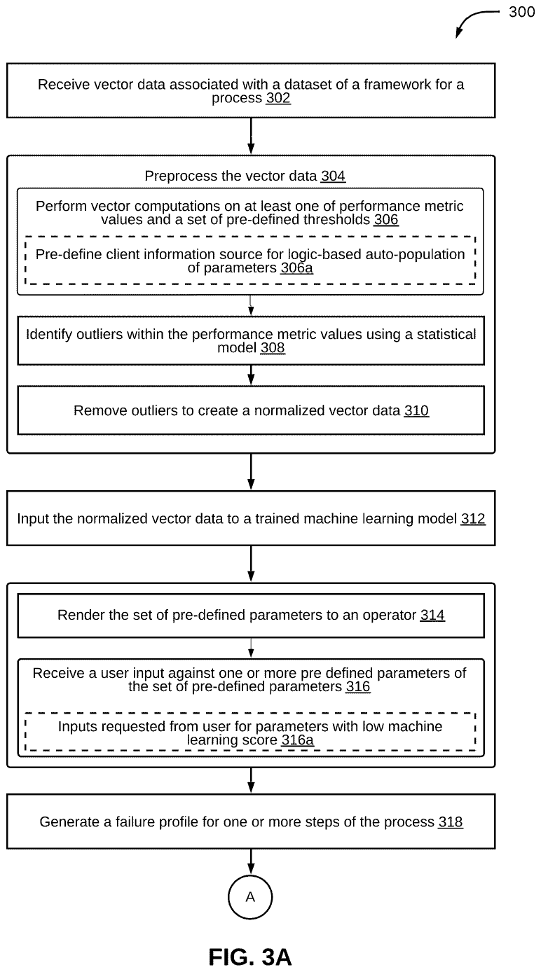

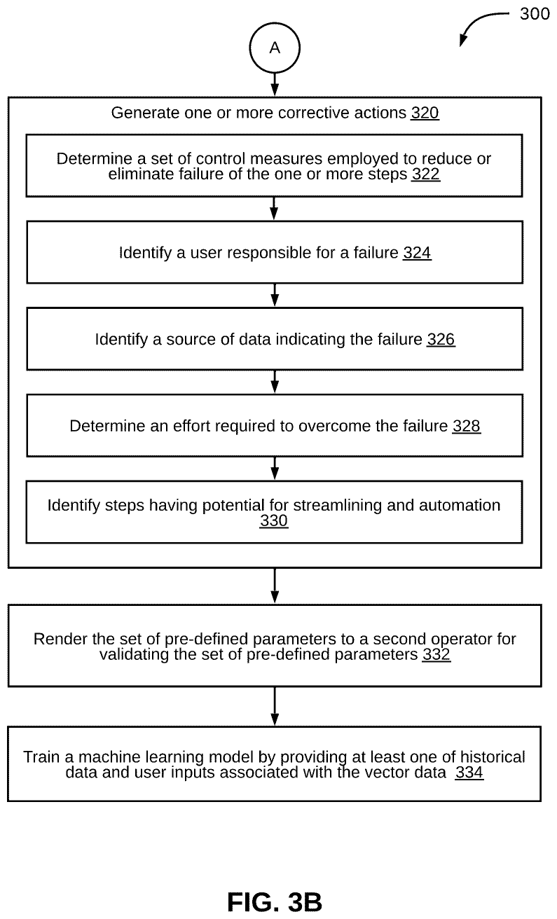

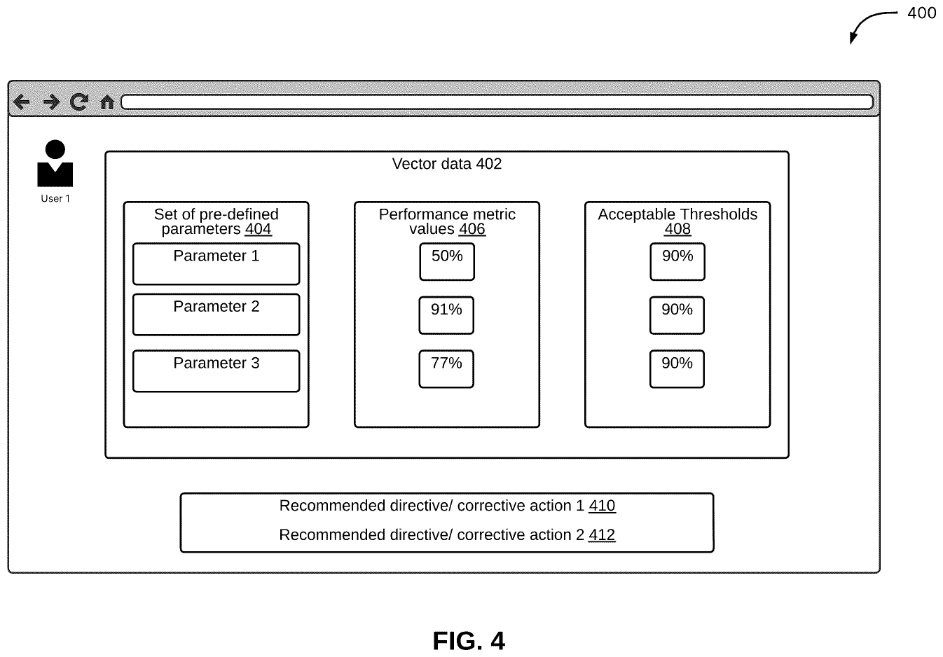

As will be described in greater detail in conjunction with FIG. 2-5, the process metrics managing device 102 may receive vector data associated with a dataset of a framework for a process. The vector data comprises a set of pre-defined parameters associated with a plurality of users. Each pre-defined parameter of the set of pre-defined parameters is associated with a user of the plurality of users based on a pre-defined role of the user. The vector data further comprises performance metric values associated with the set of pre-defined parameters in one or more steps executed in the process. The vector data further comprises a set of pre-defined thresholds pertaining to the set of pre-defined parameters. Each pre-defined threshold indicates an acceptable range of quality for each pre-defined parameter. In other words, the vector data may refer to a structured alphanumeric representation of various parameters, features and attributes within the dataset. Further, in the context of process management, the vector data may represent attributes associated with one or more roles of users involved in implementation and functioning of the process. Further, the vector data may be indicative of quantified values or performance metric values associated with performances of the users, where the quantified values may be generated upon comparison with threshold values. The threshold values may be indicative of a range of acceptable quality and production in the process. In some embodiments, the performance metric values may represent accuracy of the one or more steps of the process. In an example, the performance metric values may be represented by percentages such as 50%, 65%, 77% etc. In an example, the set of pre-defined thresholds may be represented by percentages such as 90%, 92%, 95% etc. The process metrics managing device 102 may further preprocess the vector data. The preprocessing includes performing vector computations on at least one of the performance metric values and the set of pre-defined thresholds. The preprocessing further includes identifying outliers within the performance metric values using a statistical model. The preprocessing further includes removing outliers to create a normalized vector data. In some embodiments, the preprocessing further comprises removing outliers when an assigned cause is linked to a data point to create the normalized vector data. For example, the assigned cause may refer to a task in the process and the data point may refer to the vector data in the context of project management. The preprocessing and normalization of the vector data will be later described with reference to FIG. 3 and FIG. 4. The process metrics managing device 102 may further input the normalized vector data to a trained machine learning model. The trained machine learning model is configured to predict quality and metric performance of the process in real-time. The machine learning model is further configured to recommend one or more directives upon identifying an unknown outlier within the process, and one or more corrective actions upon identifying a known outlier within the process. In some embodiments, the one or more corrective actions are generated by determining a set of current control measures employed to reduce or eliminate failure of the one or more steps, identifying a user responsible for the failure, identifying a source of data indicating the failure, determining an effort required to overcome the failure, and identifying steps having potential for streamlining and automation.

In some embodiments, the set of pre-defined parameters comprises a function of the one or more steps. The function of the one or more steps may include L1-L5 process steps as per American Productivity and Quality Center (APQC) Process Classification Framework (PCF). The APQC PCF Levels are as follows, L1—is a category, the category is a broad functional area, L2—is a process group, the process group is a subcategory, L3—is a standard process, L4—is a key activity within the process and L5—is a task/work instructions and execution details. In an example, if L1 is supply chain management, L2 is a plan for supply chain, L3 is developing supply chain plan, L4. is analyzing demand forecasts for supply chain and L5 is instructions for supply chain to meet the demand forecasts.

In some embodiments, the process steps may have respective step numbers. In some embodiments, the process metrics managing device 102 may receive the process steps from the user. In some embodiments, the process steps may include two categories, decision steps and action steps. In some embodiments, there are a set of instructions for the user to input the process steps to the process metrics managing device 102. The set of instructions are, 1. Mention every decision step as a question starting with a title ‘Decision’. 2. Every decision step will have two additional steps, they are—(a) Yes—Go to Step number ‘XX’ (b) No—Go to Step number ‘XX’. 3. Yes or No Action steps will be listed separately at the respective step numbers. 4. Multiple merge scenarios will also be tagged as Go to step no 'XX'. 5. Use cell notes for any additional information or notes related to the step.

In some embodiments, the set of pre-defined parameters further comprises a task associated with the one or more steps. In some embodiments, the set of pre-defined parameters further comprises time associated with the one or more steps. The time associated with the one or more steps may include total time of queue time, wait time, processing time and closure time. The time associated with the one or more steps is measured in hours.

In some embodiments, the set of pre-defined parameters further comprises classifications of anomalies within the one or more steps. In some embodiments, the classifications may include, 1. Waiting—average wait time when the task is handed off to cross functional team. Example—waiting for someone else to finish, waiting for responses from other departments. 2. Rework—a process step where rework is required to fulfill requirement. Manual process steps leading to manual errors. Example—duplicate data/entries that require rework, data entry/transactional errors, bugs in software. 3. Over Processing—a process step where we do the same thing repeatedly or introducing additional manual steps in a process to increase confidence level. Examples—double-checking the same document, multiple approval levels for a small request. 4. Inventory—a process step where we find supply in excess of process requirement or additional tasks assigned by process which is not defined in scope of work and may or may not be billed which can impact workforce management. In an example, if a car factory makes 10,000 cars per day but the demand for production is only for 7000 cars. The extra 3000 cars require storage, maintenance, inspection but cannot be billed to the customer. The workers need to spend extra hours on the 3000 cars and the workers fall behind schedule. In other examples—work in progress, piled up work. 5. Intellect—a process step where employee talent, skills or knowledge is not utilized or under-utilized for process improvement. Example—standard mechanical steps which are repetitive and routine that do not require high skill levels but when a high skilled worker performs this task the intellect is underutilized, automation opportunities like when manual, repetitive, or inefficient tasks can be improved using technology for example, robotic arms moving packages from point A to point B rather than a worker doing it manually, assigning staff to wrong tasks when assigned tasks that do not match expertise of a worker the efficiency is deceased.

In some embodiments, the set of pre-defined parameters further comprises a service level agreement (SLA) associated with the one or more steps. In some embodiments, the SLA may be an agreement between a client and an organization managing the process. In some embodiments, failure of the one or more steps may result in effecting the SLA between the client and the organization.

In some embodiments, the set of pre-defined parameters further comprises a source of truth associated with the one or more process steps. The source of truth is a reference to either a standard operating procedure (SOP) or any other document relevant to the process step. The source of truth may further include name of the owner of the SOP or the document. In some embodiments, the set of pre-defined parameters further comprises a team/teams involved in the process step. In some embodiments, the set of pre-defined parameters further comprises an application/system/tool used in the process step. In some embodiments, the set of pre-defined parameters further comprises a file format used in the process step. In some embodiments, the file format may be classified into two categories, a standard format and a non-standard format.

In some embodiments, the process metrics managing device 102 may include one or more processors 104 and a computer-readable medium 106 (for example, a memory). The computer-readable medium 106 may include a plurality of requirements corresponding to a plurality of applications. Further, the computer-readable storage medium 106 may store instructions that, when executed by the one or more processors 104, cause the one or more processors 104 to identify common requirements from applications, in accordance with aspects of the present disclosure. The computer-readable storage medium 106 may also store various data (for example, the vector data, and the like) that may be captured, processed, and/or required by the system 100.

The system 100 may further include a display 108. The system 100 may interact with a user via a user interface 110 accessible via the display 108. The system 100 may also include one or more external devices 112. In some embodiments, the requirements identification device 102 may interact with the one or more external devices 112 over a communication network 114, which enables data exchange between the one or more external devices through wired or wireless connections. The communication network 114 can be categorized based on coverage such as Personal Area Network (PAN), Local Area Network (LAN), Metropolitan Area Network (MAN), and Wide Area Network (WAN), based on topology (bus topology, star topology, ring topology, mesh topology, hybrid topology) and based on communication direction (simplex, half-duplex, full-duplex). The external devices 112 may include, but may not be limited to, a remote server, a digital device, or another computing system.

Referring now to FIG. 2, a functional block diagram of a process metrics managing device 200 is illustrated, in accordance with some embodiments. In an embodiment, the process metrics managing device 200 may include a graphic user interface (GUI) 202, an input module 204, a vector processing unit 206, a processor 208 and a trained machine learning model 208. In such an embodiment, the process metrics managing device 200 may be analogous to the process metrics managing device 102 of the system 100.

The process metrics managing device 200 may receive an input 212 via the GUI 202 from a plurality of users interacting with the GUI 202. In some embodiments, the input 212 is a user input against one or more pre-defined parameters of a set of pre-defined parameters. In an example, the user input may be an input given by the user against the L1-L5 process steps. In some embodiments, the GUI 202 is configured to render the set of pre-defined parameters to an operator. In some embodiments, the operator may be an admin operating the trained machine learning model 210. In some embodiments, the input module 204 is communicably coupled with the processor 208. The input module 204 is configured to receive the vector data associated with the dataset of the framework for the process, the vector data comprises the set of pre-defined parameters associated with the plurality of users. Each pre-defined parameter of the set of pre-defined parameters is associated with the user of the plurality of users based on the pre-defined role of the user. In some embodiments, the vector data further comprises the set of pre-defined thresholds pertaining to the set of pre-defined parameters. Each pre-defined threshold indicates the acceptable range of quality for each pre-defined parameter. In some embodiments the set of pre-defined parameters may be selected from at least one of the function of the one or more steps, the task associated with the one or more steps, the time associated with the one or more steps, the classifications of anomalies within the one or more steps, and the service level agreement (SLA) associated with the one or more steps.

In some embodiments, the vector processing unit 206 is communicably coupled to the input module 204. The vector processing unit 206 is configured to preprocess the vector data. The preprocessing comprises performing vector computations on at least one of the performance metric values and the set of pre-defined thresholds. The preprocessing further comprises identifying outliers within the performance metric values using the statistical model. The preprocessing further comprises removing outliers to create the normalized vector data. In some embodiments, the preprocessing further comprises removing outliers when the assigned cause is linked to the data point to create the normalized vector data. In an example, the preprocessing may be a z-score method, the z score method assumes that a variable has a Gaussian distribution. The z-score method uses the statistical method, by representing the number of standard deviations that an observation/data point is away from the mean. The statistical representation of the z-score method is z=(data point−mean)/standard deviation. In this example, the vector computations may be calculating ‘z’ using the z-score method. Here, we normally define outliers as points whose modulus of z is greater than a threshold value. This threshold value is usually greater than 2 (3 is a common value). In other examples, the preprocessing may be one following methods, Hypothesis Testing, Robust Z-score, I.Q.R method, Winsorization method (Percentile Capping), DBSCAN Clustering, Isolation Forest, Linear Regression Models (PCA, LMS), Standard Deviation, Percentile, Visualizing the data. The normalized vector data is the vector data after removing the outliers from the vector data. In some embodiments, the normalized vector data is created by removing outliers when the assigned cause is linked to the data point.

In some embodiments, the trained machine learning model 210 is executed by the processor 208. The trained machine learning model 210 comprises a neural network with one or more data processing layers. The trained machine learning model is configured to receive the normalized vector data. The trained machine learning model is further configured to predict quality and a real-time metric performance of the process. The trained machine learning model is further configured to recommend one or more directives upon identifying an unknown outlier within the process and one or more corrective actions upon identifying a known outlier within the process.

In some embodiments, the processor 208 is configured to generate a failure profile for the one or more steps, the failure profile comprises a mode of failure for an anomaly within the one or more steps, a root cause of failure, a severity of failure, and potential failure events in one or more subsequent steps of the one or more steps. In some embodiments, the mode of failure can be one of the following, receive incorrect information, receive incomplete information, receive ambiguous information, process incorrectly.

In some embodiments, the root cause of failure can be one of the following, receive incorrect information-no validation, receive incomplete information—no validation, receive ambiguous information—no defined guidelines established, process incorrectly—training gap or oversight or new process exception.

In some embodiments, the severity of the failure can be a score based on Failure Mode and Effects Analysis (FMEA) rating guidelines as reference. In some embodiments, the severity of the failure can be one of the following, customer will not notice the adverse effect (it is insignificant), customer will probably experience slight annoyance, customer will experience annoyance due to the slight degradation of performance but it does not impact the process, customer dissatisfaction due to reduced performance (i.e. they get their information late), customer is made uncomfortable or their productivity is reduced by the continued degradation of the effect, need action to fix problem for customer, high degree of customer dissatisfaction due to non-performance (incurs costs but does not completely stop customer process), very high degree of dissatisfaction, customer endangered due to the adverse effect on their performance (but can be recovered), customer endangered due to the adverse effect on their performance (i.e. loss of business, non-conformance to regulations).

In some embodiments, the failure profile further comprises a failure rate. In some embodiments, the failure rate can be one of the following, likelihood of occurrence is remote, low failure rate with supporting documentation, low failure rate without supporting documentation, low failure rate without supporting documentation, occasional failures, relatively moderate failure rate with supporting documentation, moderate failure rate without supporting documentation, relatively high failure rate with supporting documentation, high failure rate without supporting documentation, failure is almost certain based on process data or significant testing, assured of failure based on process data or significant testing.

In some embodiments, the failure profile further comprises a failure visibility. In some embodiments, the failure visibility can be one of the following, sure that the potential failure will be found or prevented before reaching the next customer, almost certain that the potential failure will be found or prevented before reaching the next customer, low likelihood that the potential failure will reach the next customer undetected, controls may detect or prevent the potential failure from reaching the next customer, moderate likelihood that the potential failure will reach the next customer, controls are unlikely to detect or prevent the potential failure from reaching the next customer, poor likelihood that the potential failure will be detected or prevented before reaching the next customer, very poor likelihood that the potential failure will be detected or prevented before reaching the next customer, current controls probably will not even detect the potential failure, absolute certainty that the current controls will not detect the potential failure.

In some embodiments, an impact is determined by the process metric managing device 200 based on rating of the severity of failure and rating of the failure visibility. In some embodiments, the impact can be one of the following, SLA failure, cost, compliance, zero tolerance policy (ZTP). In an example, if the rating of the severity of failure is 6 to 10 (business critical) and the rating of the failure visibility is 6 to 10 (end-user critical), the impact would be the SLA failure. In another example, if the rating of the severity of failure is 1 to 5 (non-critical) and the rating of the failure visibility is 1 to 5 (non-critical), the impact would be the SLA failure. In another example, if the rating of the severity of failure is 6 to 10 (business critical) and the rating of the failure visibility is 6 to 10 (end-user critical), the impact would be the cost. In another example, if the rating of the severity of failure is 1 to 5 (non-critical) and the rating of the failure visibility is 1 to 5 (non-critical), the impact would be the cost. In another example, if the rating of the severity of failure is 1 to 10 (compliance critical) and the rating of the failure visibility is 1 to 10 (compliance critical), the impact would be the compliance. In another example, if both the rating of the severity of failure and the rating of the failure visibility are not applicable as per FMEA, the impact would be the ZTP.

In some embodiments the processor 208 is further configured to generate the one or more corrective actions by determining the set of current control measures employed to reduce or eliminate failure of the one or more steps, identifying the user responsible for the failure, identifying the source of data indicating the failure, determining the effort required to overcome the failure, and identifying steps having potential for streamlining and automation.

In some embodiments, the GUI 202 is further configured to render the set of pre-defined parameters to a second operator for validating the set of pre-defined parameters. In some embodiments, the second operator may be a second admin operating the trained machine learning model 210. In an example, the set of pre-defined parameters may be the queue time, wait time, processing time, closure time associated with a task performed by the user. When the second admin receives the set of pre-defined to render. The second admin receives the queue time, wait time, processing time, closure time associated with the task as 1 minute, 2 minutes, 3 minutes, 4 minutes respectively. The second admin validates observes the maximum queue time, maximum wait time, maximum processing time, maximum closure time associated with the task should be 2 minutes, 3 minutes, 3 minutes, 3 minutes respectively. As the closure time 4 minutes is greater than the maximum closure time 3 minutes associated with task. The second admin invalidates the closure time parameter and marks the closure time parameter as an error. In this way the second admin renders the set of pre-defined parameters for validation. The second admin does Quality Control (QC) for the set of pre-defined parameters.

In some embodiments, the at least one of the set of pre-defined parameters and the performance metrics value comprises machine learning features. The machine learning features may include sensor data features, time-series features, anomaly detection features, product quality metrics, machine performance indicators, process stability features, and predictive maintenance features etc.

In some embodiments, the trained machine learning model 210 is trained by providing at least one of historical data, and user inputs associated with the set of pre-defined parameters, the performance metric values and the set of pre-defined thresholds. In some embodiments, the trained machine learning model 210 is further configured to generate the one or more corrective actions based on weight and priority assigned to each of the pre-defined parameters. In some embodiments, the trained machine learning model 210 is further configured to receive a stream of vector data in real time. The trained machine learning model 210 is further configured to automate the one or more steps of the process in real time.

Referring now to FIGS. 3A and 3B, an exemplary process 300 for managing process metrics using machine learning models via a flowchart, in accordance with some embodiments. The process 300 may be implemented by the process metrics managing device 102 of the system 100. The process metrics managing device 102 is configured to receive 302 the vector data associated with the dataset of the framework for the process. The process metrics managing device 102 is further configured to preprocess 304 the vector data. The preprocessing 304 includes performing 306 the vector computations on the at least one of the performance metric values and the set of pre-defined thresholds. Further the preprocessing may include pre-defining 306a client information source for auto-population of the parameters based on logic. The process metrics managing device 102 is further configured to identify 308 the outliers within the performance metric values using the statistical model. The process metrics managing device 102 is further configured to remove 310 outliers to create the normalized vector data. In some embodiments, the preprocessing 304 further includes removing 310 outliers when the assigned cause is linked to the data point to create the normalized vector data. The process metrics managing device 102 is further configured to input 312 the normalized vector data to the trained machine learning model. The process metrics managing device 102 is further configured to render 314 the set of pre-defined parameters to the operator. The process metrics managing device 102 is further configured to receive 316 the user input against the one or more pre-defined parameters of the set of pre-defined parameters. At 316a, inputs requested from user for parameters with low machine learning score. The process metrics managing device 102 is further configured to generate 318 the failure profile for the one or more steps of the process. The process metrics managing device 102 is further configured to generate 320 one or more corrective actions. Generating 320 one or more corrective actions includes determining 322 the set of control measures employed to reduce or eliminate failure of the one or more steps, identifying 324 the user responsible for the failure, identifying 326 the source of data indicating the failure, determining 328 the effort required to overcome the failure, identifying 330 steps having potential for streamlining and automation. The process metrics managing device 102 is further configured to render 332 the set of pre-defined parameters to the second operator for validating the set of pre-defined parameters. The process metrics managing device 102 is further configured to train 334 the machine learning model by providing at least one of the historical data and user inputs associated with the vector data.

Referring now to FIG. 4, a graphical user interface (GUI) 400 for managing process metrics using machine learning models on a computing device. In some embodiments, the GUI 400 is configured to receive the input from the user against the one or parameters of the set of pre-defined parameters 404. In some embodiments, the GUI 400 if further configured to receive the performance metric values 406 from the user against the set of pre-defined parameters 404. In some embodiments, the GUI 400 is further configured to receive the acceptable thresholds 408 against the set of pre-defined parameters 404. In some embodiments, the GUI 400 is further configured to display the one or more recommended directives/corrective actions 410, 412. In an example, the GUI 400 receives the performance metric values 406, as 50%, 91%, 77% and the GUI 400 further receives the acceptable thresholds 408, as 90%, 90%, 90% against the parameter 1, parameter 2, parameter 3 of the set of pre-defined parameters from the user respectively. Now, the GUI 400, displays the recommended directive/corrective action-1 410 to improve the performance metric value of parameter 1 from 50% to at least acceptable threshold of parameter 1 that is 90%. The GUI 400 further displays recommended directive/corrective action-2 412 to improve the performance metric value of parameter 3 from 77% to at least acceptable threshold of parameter 3 that is 90%.

Now that the system 100 for managing process metrics and the process metrics managing device 102 and the GUI 400, various components therein, and their cooperation and interaction with each other has been explained, reference is now being made to FIG. 1 and FIG. 2.

In an exemplary scenario, various workers (the plurality of users) of a healthcare company may be provided with a task of performing enrollments of senior citizens for a healthcare plan in multiple geographical locations. The performance of each worker on the task may be quantified based on the set of pre-defined parameters. The set of pre-defined parameters may include but not limited to number of days taken to complete the task, number of geographical locations covered, and resource utilization. The task may have multiple process steps including but not limited to identifying candidates in one or more geographical locations, conducting sessions for inquiries, analyzing candidature of the candidates, and accepting or rejecting enrollments.

On the basis of this task, the vector data may be generated, which may then also be supplemented by the set of pre-defined thresholds pertaining to the set of pre-defined parameters. For example, the number of workers participated in the task may be classified in three categories A, B, C. Category A may include workers who achieve 100% of their assigned enrolment targets. Category B: may include workers who achieve 95% to 99% of their assigned enrollment targets. Category C: may include workers who achieve less than 95% of their assigned enrollment targets.

The system receives vector data representing the performance of each worker in the enrollment process. This vector data includes the pre-defined parameters, corresponding performance metric values, and threshold values associated with the process. The vector processing unit preprocesses the received vector data by performing computations, identifying statistical outliers, and normalizing the data before feeding it into a machine learning model for further analysis.

As explained earlier, the vector data is required to be pre-processed and normalized in order to predict quality and metric performance of the process in real-time by using the machine learning model. The machine learning model may require an algorithm to predict the quality and the metric performance of the process in real-time. For example, the machine learning model may use a k-means algorithm. Further, the pre-processing of the vector data includes performing vector computations. In other words, the vector data have quantified values, for which the vector computations or clustering may be performed on the basis of maximum values, minimum values, constant values, average values and standard deviation.

Further the quantified values are filtered or normalized to remove the outliers. In some embodiments, the quantified values are filtered or normalized to remove the outliers when the assigned cause is linked to the data point. In other words, normalization is performed to standardize the dataset according to a specific pre-defined criterion. The vector processing unit applies the K-Means algorithm on the performance metric values to group workers into distinct performance clusters.

The system initializes K clusters, where K may be set to 3, corresponding to the worker categories A, B, and C.

Each worker's performance metric vector is assigned to the nearest cluster centroid based on an appropriate distance metric, such as Euclidean distance. The centroids are iteratively updated until convergence is achieved. Outliers are identified based on their distance from the assigned cluster centroid. If a worker's performance metric values significantly deviate from the cluster to which they are assigned, they are flagged as an outlier. If a worker's performance falls outside the pre-defined threshold range and is distant from all cluster centroids, the system classifies them as an unknown outlier and triggers a directive recommendation to investigate the anomaly. If the worker's performance deviates from their assigned cluster but remains within a historically known pattern, the system classifies them as a known outlier and provides corrective action recommendations, such as training or reassignment. To create normalized vector data, the system removes extreme outliers. In some embodiments, to create the normalized vector data, the system removes extreme outliers when an assigned cause is linked to the data point and refines the dataset before passing it to the machine learning model for process performance prediction.

Once outlier removal and vector preprocessing are completed, the normalized vector data is provided as input to the machine learning model. The neural network processes the data to recognize patterns, trends, and deviations in worker performance. The trained machine learning model evaluates the normalized vector data to predict the overall quality of the enrollment process based on historical and real-time worker performance metrics. The trained machine learning model analyzes real-time metric performance to determine deviations from expected enrollment trends. The trained machine learning model forecasts potential process inefficiencies by identifying workers or locations where enrollments are lagging.

Further, the trained machine learning model generates recommendations that may include directives if an unknown outlier is detected. For example, when a worker's performance deviates significantly from historical patterns or exhibits unexpected anomalies, the system triggers one or more directives. The directives may include escalating performance scores to the managers. The directives may further include releasing investigating orders to verify if external factors (such as incorrect data entry, sudden workload changes, or unforeseen disruptions) have impacted the worker's performance.

Further, the trained machine learning model generates recommendations that may include corrective actions if a past outlier flows into the process. For example, when a worker's performance shows a recurring deviation within a predictable range, the system suggests one or more corrective actions to improve performance and controls that can help in ensuring the performance targets are achieved. The one or more corrective actions may include skill development recommendations, such as targeted training for workers consistently falling into Category C. The one or more corrective actions may further include workload adjustments, where tasks are reassigned to workers in Categories A or B to optimize efficiency. The task classification is done based on the use of Equivalent Throughput Yield. In an example, one of the classifications may be years of experience, more experienced workers tend to make fewer mistakes, improving throughput yield. In another example, one of the classifications may be legal factors, like labour laws, work hour regulations can vary the throughput yield. The one or more corrective actions may further include modifying task distribution in geographical locations where enrolments are consistently low.

In addition to the above, the machine learning model may generate corrective actions based on the weight and priority assigned to each pre-defined parameter. For example, If “number of geographical locations covered” is assigned a higher weight than “number of days taken”, the system prioritizes workers covering more locations over the workers completing enrolments quickly. In another example, if a worker's performance is below the threshold due to higher resource utilization, the system determines whether efficiency improvement is needed or if the worker requires additional support.

The system is further configured to receive a stream of vector data in real time and automate one or more steps of the process based on continuous updates. The system may update enrolment data in real time and may dynamically adjusts task assignments based on worker availability and performance trends. For example, if the system detects a sudden drop in performance in a specific location (e.g., fewer enrolments in a particular city), the system automatically reallocates workers from high-performing regions to mild performance requirement regions. In another example, if a worker consistently underperforms in the “analyzing candidature” step, the system may automatically suggest reassignment to another task where they have historically performed better (e.g., “conducting informational sessions”).

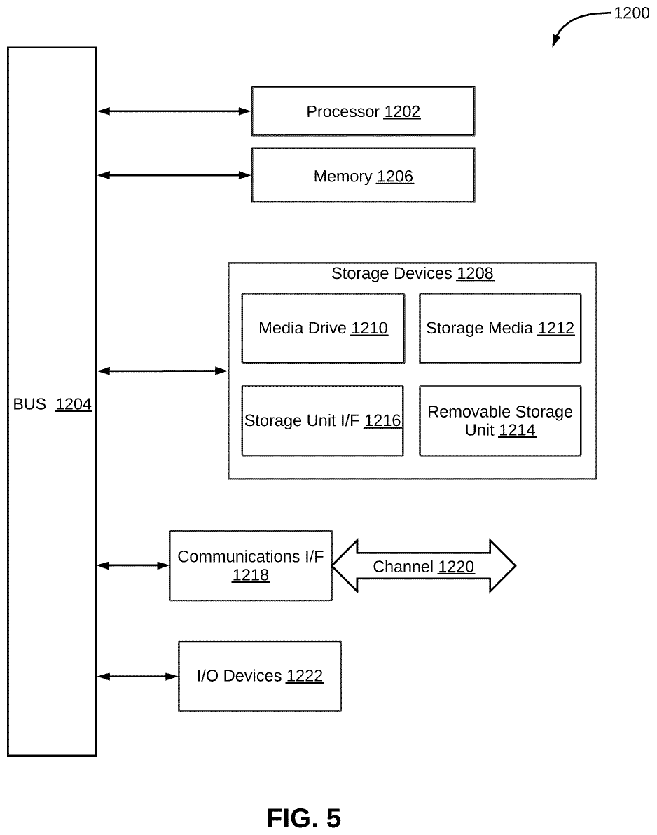

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Thus, the disclosed method and system has advantage of decreasing the error percentage in the output of the process by providing corrective recommendations by the trained machine learning model.

As will be appreciated by those skilled in the art, the techniques described in the various embodiments discussed above are not routine, or conventional, or well understood in the art.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for identifying common requirements from applications. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for managing process metrics using machine learning models, the method comprising:
receiving, via an input module, vector data associated with a dataset of a framework for a process, the vector data comprising:
a set of pre-defined parameters associated with a plurality of users, wherein each pre-defined parameter of the set of pre-defined parameters is associated with a user of the plurality of users based on a pre-defined role of the user,
performance metric values associated with the set of pre-defined parameters in one or more steps executed in the process, and
a set of pre-defined thresholds pertaining to the set of pre-defined parameters, wherein each pre-defined threshold indicates an acceptable range of quality for each pre-defined parameter;
preprocessing, via a vector processing unit, the vector data, wherein the preprocessing comprises:
performing vector computations on at least one of the performance metric values and the set of pre-defined thresholds,
identifying outliers within the performance metric values using a statistical model, and
removing outliers to create a normalized vector data; and
inputting the normalized vector data to a trained machine learning model, wherein the trained machine learning model is configured to:
predict quality and metric performance of the process in real-time, and
recommend:
one or more directives upon identifying an unknown outlier within the process, and
one or more corrective actions upon identifying a known outlier within the process.

2. The method of claim 1, wherein the method further comprises:
rendering, via a graphical user interface (GUI) client, the set of pre-defined parameters to an operator, and
receiving a user input against one or more pre-defined parameters of the set of pre-defined parameters.

3. The method of claim 1, wherein the set of pre-defined parameters is selected from at least one of:
a function of the one or more steps,
a task associated with the one or more steps,
time associated with the one or more steps,
classifications of anomalies within the one or more steps, and
a service level agreement (SLA) associated with the one or more steps.

4. The method of claim 1, wherein the method further comprises generating a failure profile for the one or more steps, the failure profile comprising:
a mode of failure for an anomaly within the one or more steps,
a root cause of failure,
a severity of failure, and
potential failure events in one or more subsequent steps of the one or more steps.

5. The method of claim 1, wherein the one or more corrective actions are generated by:
determining a set of current control measures employed to reduce or eliminate failure of the one or more steps,
identifying a user responsible for the failure,
identifying a source of data indicating the failure,
determining an effort required to overcome the failure, and
identifying steps having potential for streamlining and automation.

6. The method of claim 2, wherein the method further comprises rendering, via the GUI client, the set of pre-defined parameters to a second operator for validating the set of pre-defined parameters.

7. The method of claim 1, wherein at least one of the set of pre-defined parameters and the performance metrics value comprises machine learning features.

8. The method of claim 1, wherein the method further comprises training the trained machine learning model by providing at least one of:
historical data, and
user inputs associated with the set of pre-defined parameters, the performance metric values and the set of pre-defined thresholds.

9. The method of claim 1, wherein the one or more corrective actions are generated based on weight and priority assigned to each of the pre-defined parameters.

10. The method of claim 1, wherein the trained machine learning model is further configured to:
receive a stream of vector data in real time, and
automate the one or more steps of the process in real time.

11. The method of claim 1, wherein the preprocessing further comprises removing outliers when an assigned cause is linked to a data point to create the normalized vector data.

12. A system for managing process metrics using machine learning models, the system comprising:
a processor,
an input module communicably coupled with the processor and configured to receive vector data associated with a dataset of a framework for a process, the vector data comprising:
a set of pre-defined parameters associated with a plurality of users, wherein each pre-defined parameter of the set of pre-defined parameters is associated with a user of the plurality of users based on a pre-defined role of the user,
performance metric values associated with the set of pre-defined parameters in one or more steps executed in the process, and
a set of pre-defined thresholds pertaining to the set of pre-defined parameters, wherein each pre-defined threshold indicates an acceptable range of quality for each pre-defined parameter;
a vector processing unit communicably coupled to the input module and configured to preprocess the vector data, wherein the preprocessing comprises:
performing vector computations on at least one of the performance metric values and the set of pre-defined thresholds,
identifying outliers within the performance metric values using a statistical model, and
removing outliers to create a normalized vector data; and
a trained machine learning model, executed by the processor, comprising a neural network with one or more data processing layers, wherein the trained machine learning model is configured to:
receive the normalized vector data,
predict quality and a real-time metric performance of the process, and
recommend:
one or more directives upon identifying an unknown outlier within the process, and
one or more corrective actions upon identifying a known outlier within the process.

13. The system of claim 12, wherein the system further comprises a graphical user interface (GUI) client to render the set of pre-defined parameters to an operator, and wherein the input module is further configured to receive a user input against one or more pre-defined parameters of the pre-defined parameters.

14. The system of claim 12, wherein the set of pre-defined parameters is selected from at least one of:
a function of the one or more steps,
a task associated with the one or more steps,
time associated with the one or more steps,
classifications of anomalies within the one or more steps, and
a service level agreement (SLA) associated with the one or more steps.

15. The system of claim 12, wherein the processor is configured to generate a failure profile for the one or more steps, the failure profile comprising:
a mode of failure for an anomaly within the one or more steps,
a root cause of failure,
a severity of failure, and
potential failure events in one or more subsequent steps of the one or more steps.

16. The system of claim 12, wherein the processor is further configured to generate the one or more corrective actions by:
determining a set of current control measures employed to reduce or eliminate failure of the one or more steps,
identifying a user responsible for the failure,
identifying a source of data indicating the failure,
determining an effort required to overcome the failure, and
identifying steps having potential for streamlining and automation.

17. The system of claim 13, wherein the GUI client is further configured to render the set of pre-defined parameters to a second operator for validating the set of pre-defined parameters.

18. The system of claim 12, wherein the at least one of the set of pre-defined parameters and the performance metrics value comprises machine learning features.

19. The system of claim 12, wherein the trained machine learning model is trained by providing at least one of:
historical data, and
user inputs associated with the set of pre-defined parameters, the performance metric values and the set of pre-defined thresholds.

20. The system of claim 12, wherein the trained machine learning model is further configured to generate the one or more corrective actions based on weight and priority assigned to each of the pre-defined parameters.

21. The system of claim 12, wherein the trained machine learning model is further configured to:
receive a stream of vector data in real time, and
automate the one or more steps of the process in real time.

22. The system of claim 12, wherein the preprocessing further comprises removing outliers when an assigned cause is linked to a data point to create the normalized vector data.

23. A graphical user interface (GUI) client for managing process metrics using machine learning models on a computing device, the GUI client is configured to:
receive vector data associated with a dataset of a framework for a process, the vector data comprising:
a set of pre-defined parameters associated with a plurality of users, wherein each pre-defined parameter of the set of pre-defined parameters is associated with a user of the plurality of users based on a pre-defined role of the user,
performance metric values associated with the set of pre-defined parameters in one or more steps executed in the process, and
a set of pre-defined thresholds pertaining to the set of pre-defined parameters, wherein each pre-defined threshold indicates an acceptable range of quality for each pre-defined parameter; and
render:
the vector data to an operator,
a user input against one or more pre-defined parameters of the pre-defined parameters,
one or more directives upon identifying an unknown outlier within the process, and
one or more corrective actions upon identifying a known outlier within the process.

24. A computer program product comprising at least one non-transitory computer-readable storage medium having computer-readable program code stored therein, the computer-readable program code, when executed, cause a processor to:
receive, via an input module, vector data associated with a dataset of a framework for a process, the vector data comprising:
a set of pre-defined parameters associated with a plurality of users, wherein each pre-defined parameter of the set of pre-defined parameters is associated with a user of the plurality of users based on a pre-defined role of the user,
performance metric values associated with the set of pre-defined parameters in one or more steps executed in the process, and
a set of pre-defined thresholds pertaining to the set of pre-defined parameters, wherein each pre-defined threshold indicates an acceptable range of quality for each pre-defined parameter;
preprocess, via a vector processing unit, the vector data, wherein the preprocessing comprises:
performing vector computations on at least one of the performance metric values and the set of pre-defined thresholds,
identifying outliers within the performance metric values using a statistical model, and
removing outliers to create a normalized vector data; and
input the normalized vector data to a trained machine learning model, wherein the trained machine learning model is configured to:
predict quality and metric performance of the process in real-time, and
recommend:
one or more directives upon identifying an unknown outlier within the process, and
one or more corrective actions upon identifying a known outlier within the process.
